(19) United States
(12) Patent Application Publication
(10) Pub. No.: US 2004/0134962 A1
(43) Pub. Date: Jul. 15, 2004

(54) Stapler apparatus

(76) Inventor: Naoto Mochizuki, Yamanashi Prefecture (JP)

Correspondence Address: MICHAEL BEST & FRIEDRICH, LLP, 100 E WISCONSIN AVENUE, MILWAUKEE, WI, 53202, US

(21) Appl. No.: 10/477,306

(22) PCT Filed:
(86) PCT No.: PCT/IB02/01927

(30) Foreign Application Priority Data
May 31, 2001 (JP) 2001-165892

(51) Int. Cl. B25C 1/00

(52) U.S. Cl. 227/77

(57) ABSTRACT

Problems: To provide a stapler apparatus that clamping of the sheet bundle is smoothly shifted to staple driving operation for stapling at correct position irrespective of thickness of the sheet bundle.

Solving Means: Anvil arms 32a and 32b forming an anvil unit 30 are shaft-supported by second swing pivots 38a and 38b. There are provided activating levers 27a and 27b ends of which touch abutting protrusions 28a and 28b disposed on the anvil arms 32a and 32b, a anvil swinging shaft 37 moved reciprocally by cam members, and second springs 39a and 39b for urging the anvil arms 32a and 32b with ends of the activating levers 27a and 27b at the abutting protrusions 28a and 28b. The activating levers 27a and 27b resist against the second springs 39a and 39b to separate from the abutting protrusions 28a and 28b.

### FIELD OF APPLICATION

The present invention relates to a stapler apparatus for stapling a bundle of predetermined sheets put thereon with motor-driven staple driving means.

### PRIOR ART

Previous stapler apparatuses for automatically stapling a sheet bundle with staples have a fixed frame and a movable frame attached swingably thereto. Either one of the frames has staple driving means, and the other has staple bending means for bending ends of the staple. In the course that the fixed frame and the movable frame clamp the sheet bundle, the staple driving means forms the linear staples to a U-shape. After that, the staple bending means bends the ends of the staple passed through the sheet bundle. Cam members are provided and interlocked with a drive motor for the operations of the movable frame to clamp the sheet bundle and of the staple driving means to drive the staple into the sheet bundle. That is, the movable frame separated with a predetermined distance is moved close to the fixed frame until it contacts a surface of the sheet bundle before driving the staple in. It is known that the movable frame may have the staple driving means or the staple bending means mounted thereon.

In either type, it is needed that the movable frame is positioned with the predetermined distance from the fixed frame, places the sheet bundle onto the fixed frame, then comes close to the fixed frame, and drives the staple into the sheet bundle with it abutted to the surface of the sheet bundle. The cam members perform the clamping operation of clinching the sheet bundle. Therefore, the cam members and the movable frame must be interlocked together with levers or similar transmission members. The movable frame is different depending on thickness of the sheet bundle in movement distance from a home position (initial position) to the contact position at the surface of the sheet bundle. The moving distance is short for thick sheet bundle and long for thin one. The previous way of interlocking the cam members with the movable frame, as disclosed in, for example, Japanese Laid Open Patent Tokkai Hei 9-169006, is that a transmission member is disposed with one end thereof fitted to the cam member and the other fitted to the movable frame to transmit movement of the cam to the movable frame. In mounting the transmission member (usually lever member) on the fixed frame rotatably by a shaft, the shaft of the transmission member is put in a long hole formed on the fixed frame and is urged to the cam face by a spring as in the long hole. Therefore, the movable frame is swung by the cam with a center of an axis of the fixed frame when it is not resisted by anything. The movement of the cam is transmitted to the movable frame with the transmission member rotating with the center, prompting the movable frame to do the clamping movement. When the movable frame abuts against the surface of the sheet bundle and cannot move any more, excess movement of the cam face serves for the shaft of the transmission member to resist against the spring force to move in the long hole, and the movable frame fits to the cam face with the center of the end abutting on the sheet bundle, allowing only the end to move.

[Problems To Be Solved by the Invention]

As described above, such a previous method is disadvantageous in that in transmitting the movement of the driving cam to the movable frame by swinging of the transmission member, the shaft as the center for swinging is thrust-moved in the long hole to adjust the movement distance with the thickness of the sheet bundle. This may not allow the shaft to move smoothly in the long hole, but locks the drive system. The failure is due to looseness of the members until abutting from the driving cam to abutting of the movable frame on the sheet bundle and due to frequent non-smooth movement of the transmission member for rotation and thrusting depending on abutting condition of the movable frame on the sheet bundle. In particular, such an arrangement as the driving cam and the long hole for supporting the transmission member and the driving cam are paired right and left, is devised so that the shafts of the transmission members are passed through the right and left long holes to serve for centers of rotation and thrusting movement. Dispersion of parts of the paired members will cause the failure increase.

In view of solving the foregoing problems of the prior arts, it is an object of the present invention to provide a stapler apparatus that clamping of the sheet bundle is smoothly shifted to staple driving operation at little failure occurrence irrespective of thickness of the sheet bundle.

[Means To Solve the Problems]

The stapler apparatus according to claim 1 of the present invention is for clamping sheet bundles between a fixed frame and a movable frame for binding, equipped with a fixed frame, a movable frame pivotably mounted to the fixed frame, a staple driving means disposed on one of the fixed frame and the movable frame, a staple bending means for bending the leading ends of staples disposed on the other and a drive cam means for reciprocally moving the movable frame, wherein a transmission member comprising an abutting portion to abut one end of the movable frame, mounted rotatably pivoted to the movable frame, an activating member reciprocated by the drive cam means, interlocked to the drive cam means, and an urging means to urge the transmission member so that the abutting portion abuts the movable frame, and wherein the activating member abutting the transmission member so that the activating means separates the abutting portion from the movable frame resisting the urging means.

The invention according to claim 2 is equipped with a fixed frame, a movable frame pivotably swinging on the fixed frame, a staple driving means disposed on one of the fixed frame and the movable frame, a staple bending means to bend the leading ends of staples disposed on the other, and a drive cam means to reciprocally move the movable frame, to clamp sheet bundles between the fixed frame and the movable frame and to bind sheet bundles, wherein the movable frame is rotatably supported by a shaft on one point to the fixed frame, a transmission member comprising an abutting portion to abut the movable frame, rotatably supported on a shaft on one point on the movable frame, an urging means is disposed to urge the transmission member so that the abutting portion abuts the movable frame, the transmission member interlocked to the drive cam to separate the abutting portion from the movable frame in resistance to the urging means.

With the invention of claims 1 and 2, adjustment of the movement distance depending on thickness of the sheet bundle is not made by moving the swinging shaft of the movable frame, but by use of turning of the transmission member supported swingably by shaft on the movable frame. This feature does not need the thrusting movement of the swinging fulcrum shaft of the movable frame in the long hole as in the previous apparatus. For the reason, the shaft will not be caused in the failure that it does not move smoothly in the long hole, not resulting in locking of the drive system. Also, it is advantageous that smooth operations are assured as not affected by dispersion of parts of the members because of just swinging.

The stapler apparatus according to claim 3 of the present invention is characterized in that in the stapler apparatus in claim 1, the urging means is made up of a spring member disposed between the movable frame and the transmission member.

According to the invention, the spring member disposed between the movable frame and the transmission member is stretched by adjustment of the movement distance depending on thickness of the sheet bundle. The reaction serves for clamping the sheet bundle. This means that even for clamping only one sheet, minimum necessary clamping force can be obtained not to escape the sheet when driving the staple into the sheet.

The stapler apparatus according to claim 4 of the present invention is characterized in that in the stapler apparatus in claim 1, the urging means is made up of a spring member disposed between the transmission member and the fixed frame.

According to the invention, as the spring member does not swing together with the movable member, they can be easily arranged even in limited space.

The invention according to claim 5 is characterized in that in the stapler apparatus in claim 1 or 2, each of said movable frame and the transmission member is paired with distance from the fixed frame respectively.

According to the invention, as the paired movable frame and the paired transmission members are disposed to have the fixed frame therebetween and are urged by the respective spring members, smooth swinging operation can be made without deviation.

### Embodiments

The following describes an embodiment of the stapler apparatus of the present invention by reference to the accompanying drawings. FIG. 1 is a perspective view of an overall structure of a stapler apparatus of the present invention. FIG. 2 is a side view of the stapler apparatus shown in FIG. 1. FIG. 3 is a perspective view of main units of the stapler apparatus, including a driver unit and an anvil unit. FIG. 4 is an exploded perspective view of main parts of the driver unit. FIG. 5 is a perspective view of main units of the stapler apparatus, including a driver unit and an anvil unit. FIGS. 6 through 8 are views of main parts of drive structure of the anvil unit.

The stapler apparatus 10 in the embodiment, as shown in FIGS. 1 and 2, has a U-shaped fixed frame 11 forming the stapler apparatus 10, a driver unit 20 having drive cam means for driving a staple driving member and a staple bending member as built in the fixed frame 11, an anvil unit 30 having a movable frame as supported rotatably with respect to the fixed frame 11, and a staple supply unit 40 arranged detachably at a rear of the fixed frame 11. The driver unit 20 is structured so as to separate staples one by one from the sheet-like staple band having many staples interlocked together like a band, to form the separated staples to a U-shape, and to drive in thickness direction the staples into the sheet bundle fed in the anvil unit 30 positioned above. The anvil unit 30 arranged against the driver unit 20, on the other hand, is structured so as to receive both ends of the staple driven in the sheet bundle before to bend the both ends inward, thereby finally stapling the sheet bundle.

The fixed frame 11 has a mount 12 disposed for mounting a staple supply unit 40 at a rear thereof and has a sheet table 13 for bundling sheets at a front thereof. The fixed frame 11 also has a driver unit 20 for driving sheet-like staples fed from the staple supply unit 40 therein and has a drive motor for driving the driver unit 20 therein. The staple supply unit 40 has a cassette 41 containing the staples interlocked together like a sheet and has a holder 42 for containing the cassette 41, being detachably mounted on a mount 12 of the fixed frame 11. The driver unit 20 is described below in detail by reference to FIGS. 3 through 5. The driver unit 20 comprises a drive motor 21, deceleration gears 22, a first cam member 23, a second cam member 24, and a driver 60. The deceleration gears 22, the first cam member 23 and the second cam member 24 are assembled in a housing 25 having a partition wall therein and are swingably supported by an outside wall and the partition wall. The drive motor 21 is made up of a single dc motor an output gear 21a of which has the deceleration gears 22 interlocked thereto. The deceleration gears 22 comprise a first deceleration gear 22a, a second deceleration gear 22b, a third deceleration gear 22c, a fourth deceleration gear 22d, a fifth deceleration gear 22e, a sixth deceleration gear 22f, and a seventh deceleration gear 22g as looked outward from the output gear 21a. The sixth deceleration gear 22f is a final gear stage to swing the first cam member 23. The seventh deceleration gear 22g is a final gear stage to swing the second cam member 24.

Both the first cam member 23 and the second cam member 24 are formed of the same member and arranged in parallel with the drive motor 21. The first cam member 23 and the second cam member 24 are made up of drive gears 23a and 24a that have the torque to rotate in different directions by the sixth deceleration gear 22f and the seventh deceleration gear 22g, eccentric cams 23c and 24c that are fitted via shafts 23b and 24b, and rotating cams 23e and 24e for reciprocally moving the driver 60, respectively. The eccentric cams 23c and 24c are shaped virtually semicircle, peripheries of which drives the anvil unit 30 to swing. The eccentric cams 23c and 24c also have clincher swinging shafts 23d and 24d projected thereout for swinging a clincher unit disposed inside the anvil unit 30, respectively. The rotating cams 23e and 24e, on the other hand, are rotatably supported by the eccentric cams 23c and 24c and engaging pins 23f and 24f and are rotated in synchronization with the drive gears 23a and 24a. The rotating cams 23e and 24e have driver swinging pins 23g and 24g arranged symmetrically in a standing condition at positions separated from centers thereof on front surfaces thereof, respectively. The driver swinging pins 23g and 24g are engaged with slits 62a and 62b opened on a driver body 61, respectively. As described above, the first cam member 23 and the second cam member 24 operate the anvil unit 30, the clincher unit 50, and the driver 60 at the same time.

The driver 60, as shown in FIGS. 3 through 5, is made up of the driver body 61 having a paired horizontally long right and left slits 62a and 62b of identical shape formed thereon and of a vertically long driver head 63 disposed orthogonally with the driver body 61. The driver head 63 is formed of a plate material thickness which is virtually same as the staple at a leading edge 64 thereof. The driver head 63 has a long hole 65 for engaging a staple forming member 77 (which will be described later) in a longitudinal direction at a central portion thereof and has guide plate springs 66a and 66b disposed for engaging with the staple forming member 77 to press in while driving the staple.

The driver 60 formed as described above moves the driver head 63 one reciprocal stroke while the driver swinging pins 23g and 24g fitted with the respective slits 62a and 62b of the driver body 61 rotate one turn. This completes stapling operation. The driver swinging pints 23g and 24g are symmetrically put not to deviate an acting point for the driver 60. As described above, the driver 60 features that the rotations of the rotating cams 23e and 24e arranged symmetrically make upward or downward pushing while moving the acting points in sequence, not causing the driver head 63 to shake right or left. This allows the staples to pass securely through even a large amount of sheet bundle.

The anvil unit 30, as shown in FIG. 5, is made up of an anvil 31 for pressing the sheet bundle and paired movable frame (hereinafter referred to as anvil arms 32a and 32b) extended from respective ends of the anvil 31 for pinching both sides of the fixed frame 11. The anvil 31 has a flat sheet pressing surface 33 and a clincher covered with a cover 34 on the sheet pressing surface 33. The anvil arms 32a and 32b are made swingable with centers of first swing pivots 35a and 35b supported axially at the fixed frame 11. It should be noted that the anvil arms 32a and 32b and the fixed frame 11 are urged at their respective lower ends by the first spring 36a and 36b as shown in FIGS. 1 and 2 so that the anvil 31 can be placed at a position opened for the sheet table 13 to put the sheet bundle therein in normal state.

The anvil unit 30, as shown in FIGS. 3 and 5, has an anvil swinging shaft 37 swung as being made to abut on peripheries of the eccentric cams 23c and 24c in the driver unit 20 and by virtually elbowed transmission members (hereinafter referred to as activating levers 27a and 27b) made to abut on the anvil swinging shaft 37. The activating levers 27a and 27b, as shown in FIGS. 5 and 6, have respective ends of the anvil arms 32a and 32b supported by shaft at second swing pivots 38a and 38b. The activating levers 27a and 27b are fitted at ends thereof with respective abutting protrusions 28a and 28b disposed to project on respective ends of the anvil arms 32a and 32b as urged by second springs 39a and 39b. Swinging of the activating levers 27a and 27b, as shown in FIG. 7, is made by the anvil swinging shaft 37 abutted on the peripheries of the eccentric cams 23c and 24c. The anvil swinging shaft 37 is reciprocally moved up and down once while contacting the peripheries of the eccentric cams 23c and 24c as the eccentric cams 23c and 24c rotate one turn. Such a vertical reciprocal movement resists against the first spring 36a and 36b urged to the fixed frame 11 to press down the activating levers 27a and 27b. The anvil arms 32a and 33b are moved down with centers of the first swing pivots 35a and 35b to clamp the sheet bundle put on the sheet table 13.

FIG. 8 is views of another embodiment of the anvil swinging shaft. The anvil swinging shaft 37a in the embodiment has small rollers 23k and 24k built thereon in parallel with the paired shafts 23b and 24b. The rollers 23k and 24k are supported to contact peripheries of the eccentric cams 23c and 24c. Such an anvil swinging shaft 37a allows for further smooth rotations of the eccentric cams 23c and 24c and less noise during driving as having the rollers 23k and 24k arranged.

The following describes operation of the anvil unit 30 by reference to FIG. 9. The figures for steps a through e are views showing a clamping operation of the sheet bundle, particularly in movements of the paired anvil arm 32a and the activating lever 27a. The following description is for the component members and symbols on one side, but same as on the other sides. Steps a through c described below are of operations of clamping the sheet bundle.

Step a. The figure shows a state before clamping the sheet bundle. The anvil 31 is stopped at a position farthest from the sheet table 13. The anvil arm 32 in the state is urged to swing clockwise with a center of the first swing pivot 35a by the first spring 36a as the anvil swinging shaft 37 is at a position escaped from the cam face of the above-mentioned eccentric cam 23c. The anvil swinging shaft 37 is brought up to a highest position by the activating lever 27a abutting on the abutting protrusion 28a on the anvil arm 32a by the second spring 39a, the activating lever 72a being supported by shaft with a center of the second swing pivot 38a together with the anvil arm 32a. In such a state, the anvil arm 32a abuts on a stop of an apparatus frame (not shown) by the first spring 36a to keep in the initial state that opens a space available for loading the bundle of maximum allowable sheets to staple.

Step b. When a staple start signal is received from an external apparatus with the sheet bundle placed in position on the sheet table 13 in step a before, the eccentric cam 23c starts rotation. At the same time, the anvil swinging shaft 37 presses down the activating lever 27a to resist against the first spring 36a. Then the anvil arm 32a starts turning toward the sheet table 13 with the center of the first swing pivot 35a. In the event, the second spring 39a turns the activating lever 27a and the anvil arm 32a together. The state becomes one that the maximum allowable bundle sheets can be stapled.

Step c. The anvil arm 32a turns further. The figure shows the state that zero to several sheets are clamped.

The following steps d and e are for a bundle thickness absorption operation to adjust the moving distance for thickness of the sheet bundle with turning of the eccentric cam 23c after clamping the sheet bundle at steps b and c above.

Step d. First, when the anvil 31 clamps the sheet bundle of a desired thickness in the state of step b, the anvil arm 32a stops swinging once. Even in the state, the eccentric cam 23c continues rotation further to press the anvil swinging shaft 37 downward. This resists against urging of the second spring 39a to rotate the activating lever 27a counterclockwise until the eccentric cam 23c rotates one turn. Also the reaction given by the rotation of the activating lever 27a resisting against the urging force of the second spring 39a allows the anvil 31 to clamp the sheet bundle. This completes the clamping operation the force of which is enough not to escape the sheet bundle when the staple is driven in upward. The clamping operation also prevents the activating lever 27a and the eccentric cam 23c from being damaged. Step 3. The figure shows the state that the sheet bundle is thinner than at step d. The operation is similar to step d above. Description is omitted.

As explained above, the anvil unit 30 having the arrangement mentioned above can perform secure clamping operation irrespective of the thickness of sheet bundle.

The cover 34 of the anvil 31 has the clincher unit 50 disposed therein. The clincher unit 50 is an arrangement for bending edges of the staples passed through the sheet bundle by the driver head 63 inside the driver 60. The clincher unit 50, as shown in FIG. 10, is made up of paired clinchers 51a and 51b for guiding to open and close the both edges of the staples, a clinch plate 52 for pressing at centers of clinchers 51a and 51b to bend the both edges of the staples, and a U-shaped clinch arm 53 supported swingably at the first swing pivots 35a and 35b of the anvil arms 32a and 32b. The clinch arm 53 is rotatably supported at the first swing pivots 35a and 35b on the fixed frame 11 together with the anvil arms 32a and 32b. After the anvil arms 32a and 32b support the sheet bundle by clamping it, the clinch arm 53 is independently swung with centers of the first swing pivots 35a and 35b by joint levers 26a and 26b interlocked with the clinch swinging pins 23d and 24d. The clinch arm 53 then moves the clinch plate 52 interlocked with the clinch arm 53. The joint levers 26a and 26b, as shown in FIG. 2, are rotatably supported at the respective swing pivots of the anvil arms 32a and 32b and the clinch arm 53. The joint levers serve to transmit swinging of the first cam member 23 and the second cam member 24 in the driver unit 20 to the anvil unit 30 and the clinch unit 50.

FIG. 11 shows a staple feeding arrangement 70 for sequentially feeding the band-shaped staples 43 held in the staple supply unit 40 toward the driver 60 and the clincher unit 50. The staple feeding arrangement 70 has a staple feeding lever 71 supported swingably on the fixed frame 11 via the staple swinging shaft 73, a staple feeding pawl 72 disposed at an end of the staple feeding lever 71, and a plate spring 74 for urging the staple feeding lever 71 to a predetermined position. Feeding the band-shaped staple 43 is made by rotating the drive gears 23a and 24a with the drive motor 21. The rotation allows staple feeding pings 23h and 24h mounted to stand at the drive gears 23a and 24a pushes rightward the staple feeding lever 71 supported to resist against the plate spring 74. This hooks the staple feeding pawl 72 on the staples 43. When the drive gears 23a and 24a are rotated, further, the staple feeding pins 23h and 24h are taken out of the staple feeding lever 71, which is then pushed back leftward by force of the plate spring 74. In such an operation, the staples 43 are fed out toward a bending block 75 (which will be later) by the staple feeding pawl 72.

The staples 43 moved forward sequentially by the staple feeding arrangement 70, as shown in FIG. 12, are abutted against a staple catching groove of the square bending block 75 disposed at a front of the fixed frame 11. A staple forming member 77 placed through a homer pin 76 at a long hole 65 of the driver head 63, then can form the staple 43 to U-shape as the driver head 63 moves up. After that, the both side plate springs 66a and 66b on the driver head 63 are moved on guide blocks 78a and 78b. This disengages the plate springs 66a and 66b from the staple forming member 77. Only the driver head 63 pushes up the U-shaped staple 43 onto the anvil 31 positioned further upward to pass it through the sheet bundle. The clincher unit 50 bends the both legs of the staple 43, completing the stapling operation.

FIG. 13 shows the sequential stapling operation of the stapler apparatus 10 as looked to the front thereof. The following describes operation steps in the order shown in the figure.

a. Initial State

This shows a state right before start of the stapling operation. The staple 43 is fed under the bending block 75 by the means described by reference to FIGS. 11 and 12. The sheet bundle 79 is aligned on the sheet table 13. The driver 60 is put at a home position at the bottom, while the anvil 31 is open as separated away from the sheet bundle 79.

b. Sheet Bundle Clamping State

When a stapling start signal is received in the state a above, the paired rotating cams 23e and 24e start rotation in arrow directions. The rotations of the rotating cams 23e and 24e make the driver swinging pins 23g and 24g press the driver 60 up. At the same time, through the serial operations shown in FIG. 9, the anvil 31 moves down to clamp the sheet bundle 79 in the sheet table 13.

c. Staple Forming State

The staple forming member 77 bends upward the both ends of the staple 43 put on the bending block 75 as interlocked with upward movement of the driver 60 in step b above.

d. Stapling Start State

The driver 60 and the staple forming member 77 are disengaged from the state at step c above. Only the driver 60 moves up. The end 64 on the driver head 63 then is butted against the U-shaped staple 43. The staple 43 is at the state right before being driven into the sheet bundle 79.

e. Stapling Setup State

When the driver 60 moves up further from the state at step d above, the both ends on the U-shaped staple 43 are passed through the sheet bundle 79 and run into the clinchers 51a and 51b, allowing clinching to start.

f. Clinching State

Finally, the clinching plate 52 is pushed down to bend the both ends of the staple inward. This ends the sequence of stapling operations.

The operations at steps a to f can be completed in a single turn of the driver swinging pins 23g and 24g made to stand on the rotating cams 23e and 24e. As described so far, the stapler apparatus 10 according to the present invention is excellently stable as the drive parts are driven by the two systems of cam members 23 and 24 of identical members. In particular, the rotating cams 23e and 24e and the driver swinging pins 23g and 24g for driving the driver 60 can perform smooth driving as they are symmetrical in shape and position.

FIG. 14 is a timing chart illustrating the sequential operations of the stapler apparatus. The sequential operations are described below by reference to FIGS. 14, 2, and 3 through 5. The drive motor 21 starts rotation as receiving the stapling start signal from an apparatus body (not shown). The drive motor 21, as shown in FIG. 3, transmits rotational torque through the deceleration gears 22 to the first cam member 23 and the second cam member 24. The first cam member 23 and the second cam member 24 start swinging of the anvil unit 30 first, which is large in amount of swinging. The sheets are clamped in a range of an amount of swing for two sheets (85 degrees of the sixth deceleration gear 22f) to an amount of swing for 50 sheets shown by dotted line in the figure. In the start, swinging of the anvil swinging shaft 37 butted against the eccentric cams 23c and 24c is absorbed by the second springs 39a and 39b as the anvil unit 30 clamps the sheet bundle not to swing further. The driver 60 driven by the rotating cams 23e and 24e is moved a little later after swinging of the anvil unit 30. The staple forming member 77 interlocked with the driver 60 forms the staples 43 to U-shape before the driver head 63 drives the U-shaped staple 43 in position on the sheet bundle. After driving, the clincher unit 50 is returned up first by spring force together with release of the cam members. Then the anvil unit 30 also is returned up by spring force together with release of the cam members. At the same time, also, the driver unit 20 is returned down with release of the cam members, being reset to the home position.

The embodiments described so far have the anvil unit 30 swung to clamp the sheet bundle between it and the driver unit 20 placed in position. Alternatively, of course, the driver unit 20 can be swung, and both the driver unit 20 and the anvil unit 30 can be swung one another.

### BRIEF DESCRIPTION OF THE DRAWINGS

FIG. 1 is a perspective view of an overall structure of a stapler apparatus of the present invention.

FIG. 2 is a side view of the stapler apparatus shown in FIG. 1.

FIG. 3 is a perspective view of main parts of the driver unit.

FIG. 4 is a perspective exploded view of the driver unit.

FIG. 5 is a perspective view of main units of the stapler apparatus, including a driver unit and an anvil unit.

FIG. 6 is a cross-sectional view of main parts of cam members and operating levers.

FIG. 7 is a view of main parts of an eccentric cam and an anvil swinging shaft.

FIG. 8 is a view of main parts of another embodiment of the eccentric cams and the anvil swinging shaft.

FIG. 9 is an illustration showing a clamping operation of a sheet bundle.

FIG. 10 is a perspective view of main parts of a clincher unit.

FIG. 11 is a perspective view of main parts of a staple feeding arrangement.

FIG. 12 is an illustration showing a forming structure of staples.

FIG. 13 is an illustration showing a sequential operation of the staples.

FIG. 14 is a timing chart showing the sequential operation of the staples in FIG. 11 above.

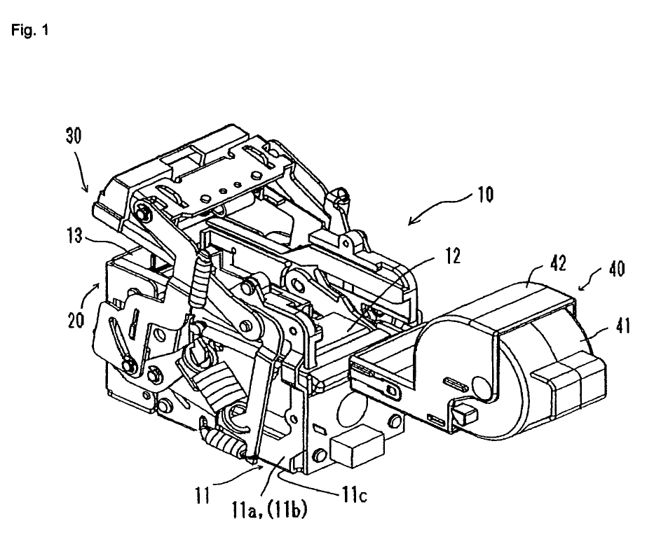

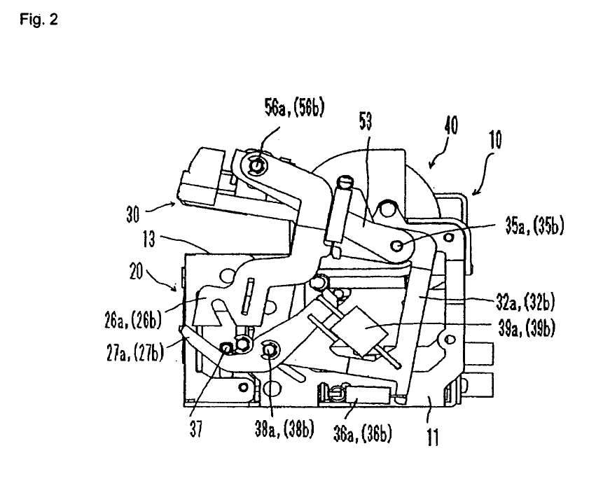

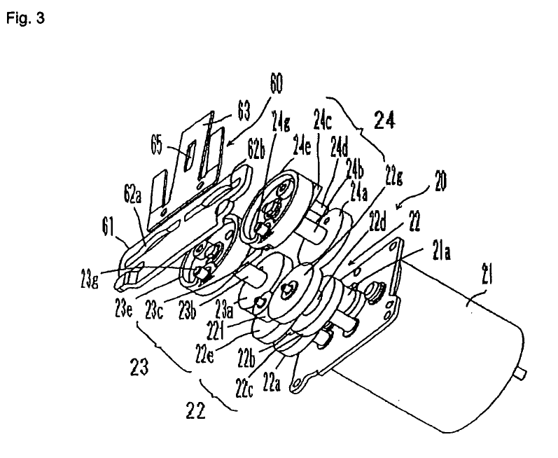

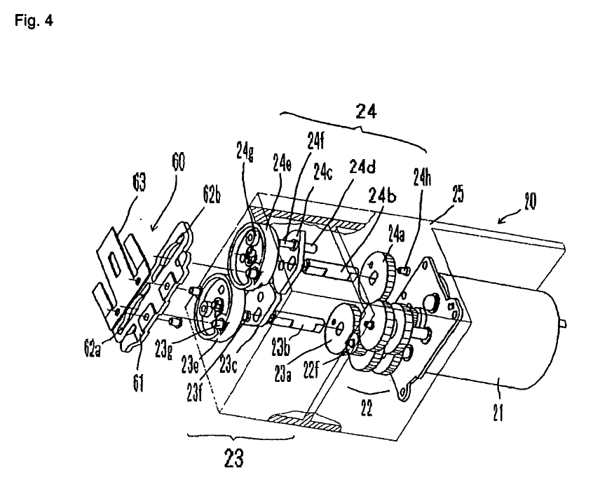

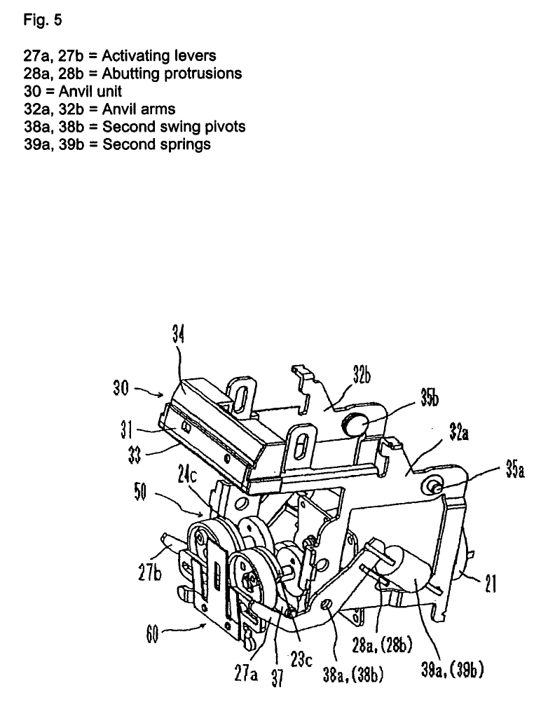

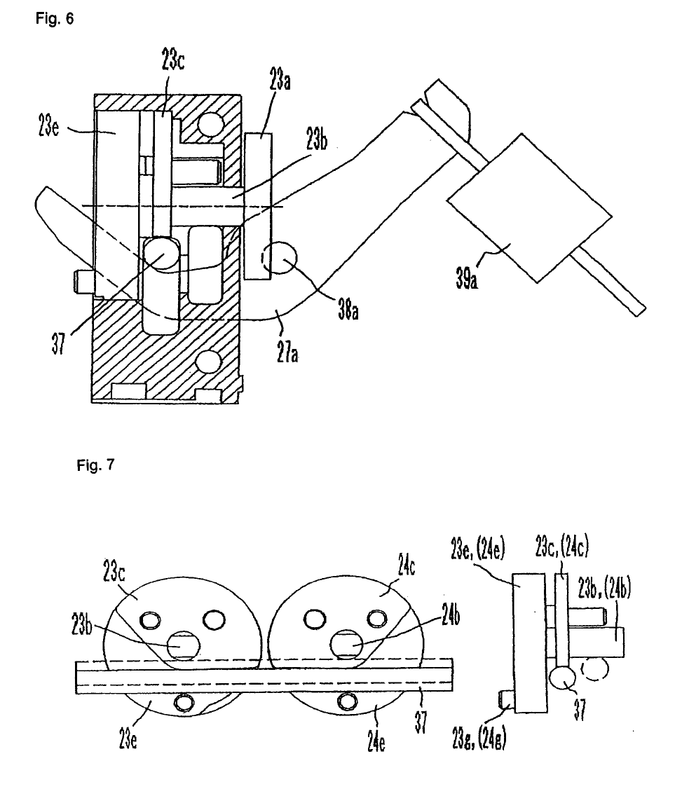

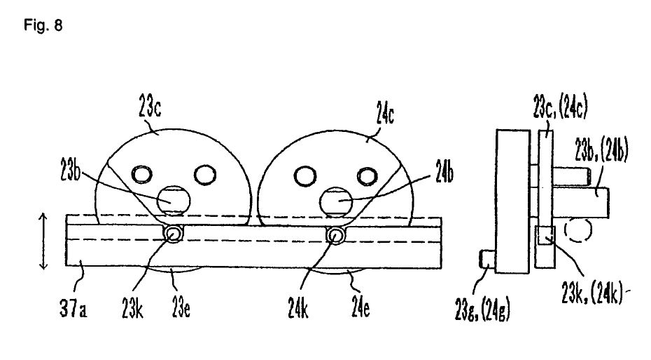

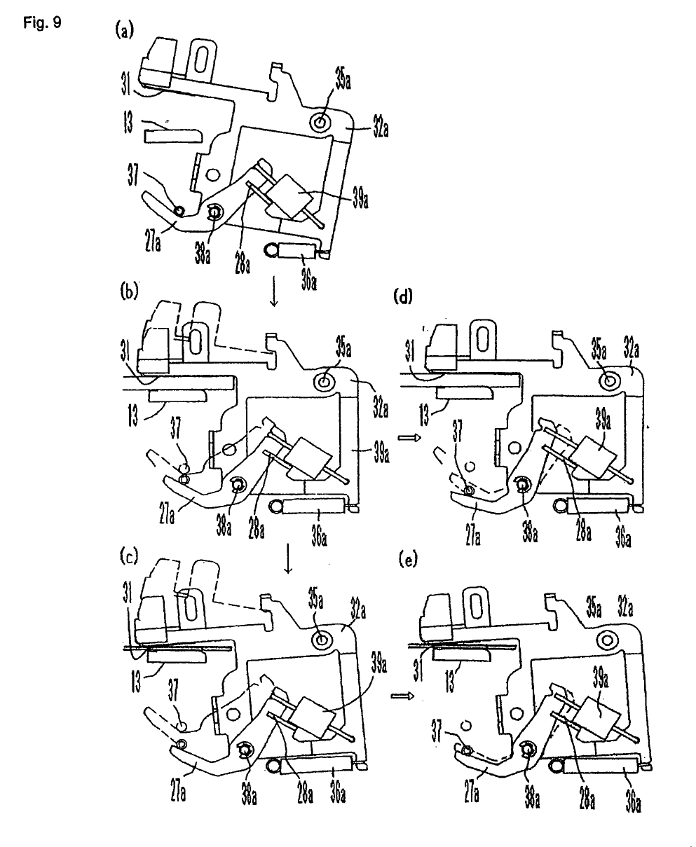

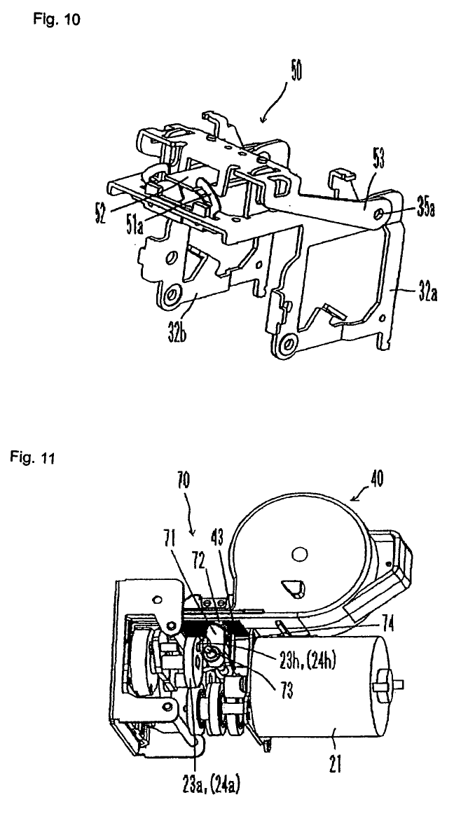

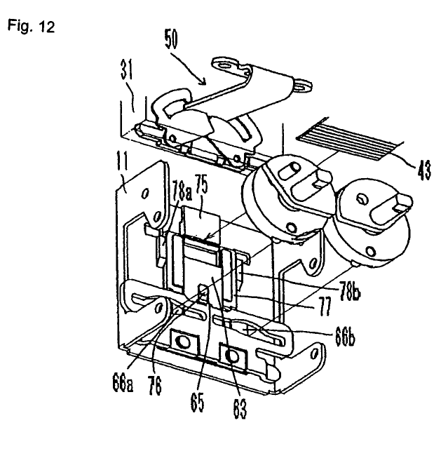

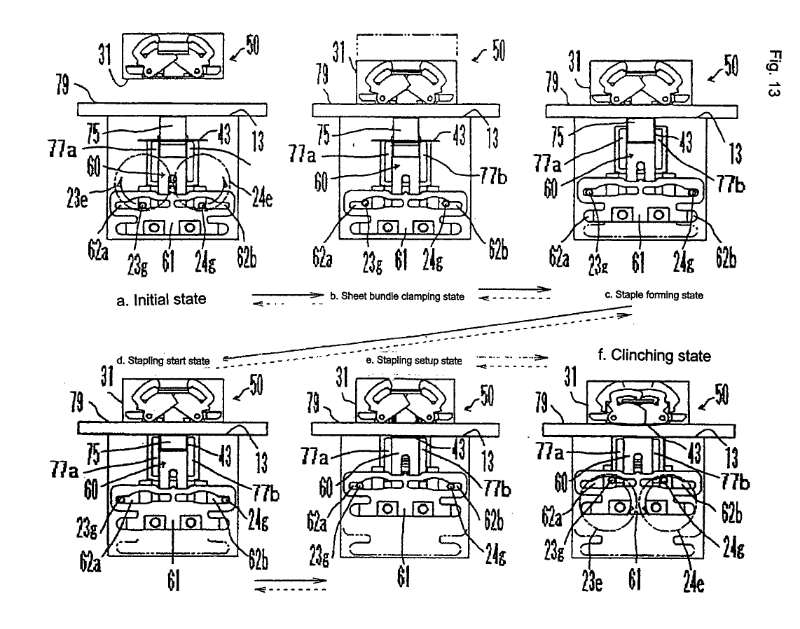

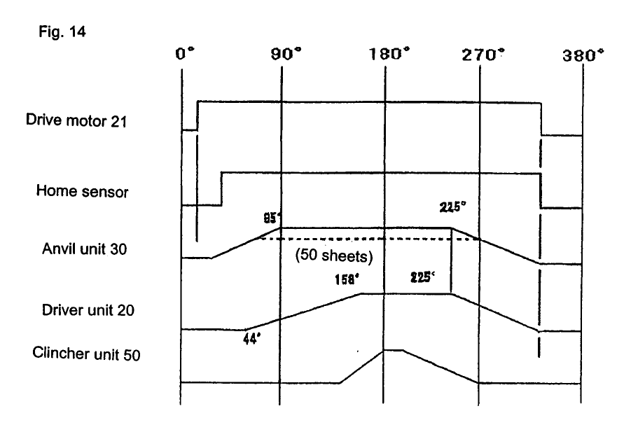

### SYMBOLS

10=Stapler apparatus

20=Driver unit

21=Drive motor

23=First cam member

24=Second cam member

27a and 27b=Activating levers

28a and 28b=Abutting protrusions

30=Anvil unit

32a and 32b=Anvil arms

38a and 38b=Second swing pivots

39a and 39b=Second springs

40=Staple supply unit

50=Clincher unit

60=Driver

70=Staple feeding arrangement

Scope of claim for a patent

1. A stapler apparatus for clamping sheet bundles between a fixed frame and a movable frame for binding, equipped with a fixed frame, a movable frame pivotably mounted to said fixed frame, a staple driving means disposed on one of said fixed frame and said movable frame, a staple bending means for bending the leading ends of staples disposed on the other and a drive cam means for reciprocally moving said movable frame, wherein:
a transmission member comprising an abutting portion to abut one end of said movable frame, mounted rotatably pivoted to said movable frame, an activating member reciprocated by said drive cam means, interlocked to said drive cam means, and an urging means to urge said transmission member so that said abutting portion abuts said movable frame, wherein said activating member abutting said transmission member so that said activating means separates said abutting portion from said movable frame resisting said urging means.

2. A stapler apparatus equipped with a fixed frame, a movable frame pivotably swinging on said fixed frame, a staple driving means disposed on one of said fixed frame and said movable frame, a staple bending means to bend the leading ends of staples disposed on the other, and a drive cam means to reciprocally move said movable frame, to clamp sheet bundles between said fixed frame and said movable frame and to bind sheet bundles, wherein:
said movable frame is rotatably supported by a shaft on one point to said fixed frame, a transmission member comprising an abutting portion to abut said movable frame, rotatably supported on a shaft on one point on said movable frame, an urging means is disposed to urge said transmission member so that said abutting portion abuts said movable frame, said transmission member interlocked to said drive cam to separate said abutting portion from said movable frame in resistance to said urging means.

3. The stapler apparatus according to claim 1, wherein said urging means is made up of a spring member disposed between said movable frame and said transmission member.

4. The stapler apparatus according to claim 1, wherein said urging means is made up of a spring member disposed between said transmission frame and said fixed frame.

5. The stapler apparatus according to claim 1 or 2, wherein each of said movable frame and said transmission member is paired with distance from said fixed frame respectively.
